(19) United States
(12) Patent Application Publication
(10) Pub. No.: US 2020/0406928 A1
(43) Pub. Date: Dec. 31, 2020

(54) METHOD FOR CONTROLLING A VEHICLE

(71) Applicant: Robert Bosch GmbH, Stuttgart (DE)

(72) Inventors: Alexander Rausch, Rheinstetten (DE); Christian Heinzemann, Ludwigsburg (DE); Dirk Ziegenbein, Freiberg Am Neckar (DE); Jens Oehlerking, Stuttgart (DE); Martin Butz, Steinheim An Der Murr (DE); Martin Herrmann, Korntal (DE); Matthias Woehrle, Bietigheim-Bissingen (DE); Michael Rittel, Markgroeningen (DE); Nadja Schalm, Renningen (DE)

(21) Appl. No.: 16/894,277

(22) Filed: Jun. 5, 2020

(30) Foreign Application Priority Data
Jun. 28, 2019 (DE) 102019209544.5

(51) Int. Cl. B60W 60/00; B60W 40/09; B60W 40/06; B60W 10/20

(52) U.S. Cl. CPC B60W 60/0016; B60W 40/09; B60W 40/06; B60W 10/20; B60W 60/00184; B60W 2050/146; B60W 2556/40; B60W 2555/20; B60W 2552/53; B60W 2552/30; B60W 60/0027

(57) ABSTRACT

A computer-implemented method for controlling a vehicle. The method includes: data of a digital road map are read in, zones are determined for the digital road map, possible sequences of drives along a road of the digital road map are ascertained as a function of the determined zones, a behavior of the vehicle or of a vehicle system of the vehicle is ascertained in a simulation for at least one of the possible sequences, and the vehicle is controlled in accordance with one of the possible sequences as a function of a comparison of the ascertained behavior with at least one predetermined requirement.

### CROSS REFERENCE

The present application claims the benefit under 35 U.S.C. § 119 of German Patent Application No. DE 102019209544.5 filed on Jun. 28, 2019, which is expressly incorporated herein by reference in its entirety.

### FIELD

The present invention relates to a computer-implemented method for controlling a vehicle, in particular, for the behavior planning and trajectory planning or maneuver planning for an at least semi-autonomous vehicle and for controlling the at least semi-autonomous vehicle as a function of the behavior planning and trajectory planning or maneuver planning.

### BACKGROUND INFORMATION

An important component for the development of highly automated or autonomous vehicles is the validation of the driving functions for a preferably large number of situations and scenarios. The validation in this case is to ensure that vehicle systems fulfill certain requirements, in particular, safety requirements, in the respective situations and thus ensure a desired setpoint behavior of the vehicle.

Among the previous methods, there are, for example, rigid scenario catalogs, which describe a fixed set of exemplary, mostly country-specific, sequences. On this basis, however, the determination of a cover profile for the validation is hardly possible, even among users of ontologies. Very long lists of scenarios quickly become necessary in order to even achieve a minimal cover profile.

Other measures for validation include evaluations of accident databases or endurance tests using security drivers. In both methods, a cover highly subject to chance takes place, the latter method in particular is also very complex and cost-intensive.

A variation of primarily physical parameters of a given simulation scenario may take place via fuzzing or optimization-based testing (for example, search-based testing). No systematic abstraction of prevailing traffic situations takes place, however, as a result of which here, too, a cover profile may be determined only with great difficulty.

In addition to simulative tests of vehicle systems, it is also possible to achieve online a suitable behavior planning and trajectory planning or maneuver planning for controlling the vehicle using models or simulations in the vehicle.

A method and device for creating and providing a highly accurate map are described in German Patent Application No. DE 10 2017 207257 A1. A device for validating diagnostic commands to a control unit is described in German Patent Application No. DE 10 2018 214999 A1. German Patent Application No. DE 10 2017 216801 A1 describes a method for monitoring at least one component of a motor vehicle, which is used for the trajectory planning.

### SUMMARY

In accordance with an example embodiment of the present invention, a computer-implemented method for controlling a vehicle is provided, including the steps:
data of a digital road map are read in,
zones are determined for the digital road map,
possible sequences of drives along a road of the digital road map are ascertained as a function of the determined zones,
a behavior of the vehicle or of a vehicle system of the vehicle is ascertained in a simulation for at least one of the possible sequences,
the vehicle is controlled in accordance with one of the possible sequences as a function of a comparison of the ascertained behavior with at least one predetermined requirement.

The digital road map in this case may be a detailed road map, but may also be provided by data of an abstract road scheme. It may contain, in particular, pieces of information about at least one road or open space, for example, about roadway width, roadway boundaries, positions or extensions of the road or the open space, curve radii, roadway markings, intersections, traffic lights and traffic signs.

With the example method according to the present invention, it is possible, in particular, to generate a dynamic online planner for autonomous or at least semi-autonomous vehicles, which analyzes online the possible scenarios based on the identified instantaneous map segment configuration and subject population and plans and pilot-controls or controls the behavior of the vehicle. Such a behavior planner and trajectory planner or maneuver planner in this case may be used independently or together with additional behavior planners, trajectory planners or maneuver planners.

In preferred embodiments of the present invention, the determined zones include at least one static zone, the size of which results from static elements of the digital road map, and at least one dynamic zone, the size of which is a function of a characteristic of at least one additional road user, in particular, of a dynamic state of the additional road user, or of a characteristic of a vehicle that includes the vehicle system, in particular, of a dynamic state of the vehicle. The characteristic of the at least one additional road user in this case is ascertained preferably from a behavior model relating to the road user, in particular, from a physical movement model relating to the road user.

In preferred embodiments of the present invention, the determined zones abstracted from the digital map are determined as logical zones and a zone graph relating to the determined zones of the digital map is ascertained, as a function of which the possible sequences are ascertained. The possible sequences in this case may be subdivided into equivalence classes, those sequences of the possible sequences in which an identical setpoint behavior for the vehicle system is applicable being assigned to the same equivalence class. A phase graph may also be generated as a function of the zone graph and of the equivalence classes, as a function of which the possible sequences are ascertained. A cover profile of the possible sequences is preferably ascertained as a function of the assignment to the equivalence classes.

In one preferred embodiment of the present invention, zones for which a cover is critical are identified as a function of the digital map, of the determined zones and of the possible sequences. The control may take place as a function of the fact that a possible cover is determined for the identified zones based on input variables. The input variables in this case may include pieces of information about external influences, in particular, weather data, pieces of road information, in particular, pieces of development information, pieces of information about additional road users, in particular, their size, pieces of information about an object that impedes an intended behavior of a vehicle that includes the vehicle system, or pieces of information about sensors of the vehicle system. Requirements for a perception of the vehicle system or of a vehicle that includes the vehicle system may, in particular, also be created as a function of the identified zones, as a function of which the control may take place.

In preferred embodiments of the present invention, an error message is output or the vehicle or a vehicle system of the vehicle is deactivated or the vehicle or a vehicle system of the vehicle is transferred into a safe state or a substitute reaction takes place if none of the possible sequences fulfills the requirement. Alternatively or in addition, the vehicle may also be automatically improved in this case.

In preferred embodiments of the present invention, the ascertainment of the possible sequences is a function of pieces of information about at least one additional road user, in particular, about a vehicle or a pedestrian, or of pieces of information about an object, which impedes an intended behavior of the vehicle. The ascertainment of additional input variables may also be a function, in particular, of pieces of information about external influences, of pieces of information about additional road users, of pieces of information about an existing or planned route of the vehicle or pieces of information about a vehicle system of the vehicle or about the vehicle.

The predetermined requirement advantageously includes a traffic regulation, a safety requirement for a movement behavior of the vehicle or of a vehicle system of the vehicle or a comfort requirement according to the specification of the vehicle or of a vehicle system of the vehicle.

The example methods may be carried out, in particular, on a computer online in the vehicle. For this purpose, a computer program is executed, which is configured to carry out the method and which is stored for processing in a machine-readable memory.

The example methods described herein allow for a structured derivation of desired behaviors of a vehicle system or of a vehicle. In this case, the guarantee of a completeness of the considered scenarios with respect to known influence factors, in particular, also becomes possible, preferably via a structured definition of equivalence classes on the basis of known features and effects that occur in road traffic. An automated redundancy analysis and gap analysis is just as possible as a definition and ascertainment of cover profiles.

The example methods described herein also achieve a significant reduction of the description complexity of the scenarios to be validated, the scope of the description may be exponentially reduced.

The example methods described herein are very flexible and modular. Important influence factors may be added in an additive manner, existing scenarios are maintained, but may also be automatically expanded by the new influence factors. The model-based approach allows for simple transferability to other countries. A modular description of the individual effects that contribute to a complex behavior decision (for example, consideration of a pedestrian crosswalk separate from an intersection at which it is located) is enabled by an abstraction of traffic situations into logical zones. This results in a high reduction of the complexity and a high degree of reusability.

A structured, largely automated derivation of a complete scenario consideration for autonomous vehicles (auto, robot, autonomous industrial truck, etc.) is achieved based on generic traffic segments and subject populations, which enable a validation of the HAD systems of vehicles, in particular, for behavior planning and trajectory planning.

Specific embodiments of the present invention are explained in greater detail below with reference to the figures.

### BRIEF DESCRIPTION OF THE DRAWINGS

FIG. 1 schematically shows an exemplary sequence of a method for controlling a vehicle in accordance with the present invention.

FIG. 2 schematically shows a first exemplary detail from a digital road map including plotted zones in accordance with the present invention.

FIG. 3 schematically shows two zone graphs derived from zones of a digital road map in accordance with the present invention.

FIG. 4 schematically shows a first behavior model for a behavior of a vehicle in accordance with the present invention.

FIG. 5 schematically shows a second behavior model for a behavior of a vehicle in accordance with the present invention.

FIG. 6 schematically shows a second exemplary detail from a digital road map including plotted zones in accordance with the present invention.

FIG. 7 schematically shows a zone graph derived from zones of a digital road map in accordance with the present invention.

FIG. 8 schematically shows a first phase graph derived from a zone graph in accordance with the present invention.

FIG. 9 schematically shows a third exemplary detail from a digital road map including plotted zones in accordance with the present invention.

FIG. 10 schematically shows a second zone graph derived from zones of a digital road map in accordance with the present invention.

FIG. 11 schematically shows a second phase graph derived from a zone graph in accordance with the present invention.

### DETAILED DESCRIPTION OF EXAMPLE EMBODIMENTS

The example methods in accordance with the present invention are described below with reference to an at least semi-autonomous or highly automated vehicle or to a vehicle system of the vehicle. A vehicle system in this case may, in particular, be a sub-system of the vehicle. In particularly preferred embodiments, the vehicle or vehicle system includes at least one computer program, which prompts actuator interventions as a function of sensor values, in particular, by undertaking a behavior planning for the vehicle as a function of the sensor values and prompts actuator interventions for implementing the latter. Thus, for example, pieces of surroundings information may be detected by sensors of the vehicle and a steering, acceleration or brake application may be prompted as a function of the detected sensor values.

Possible vehicle systems of such a vehicle may include a perception layer or sensor layer, a layer for situation analysis and prediction, a layer for selecting a desired vehicle behavior from potential behavior patterns and/or a layer for controlling actuators for achieving the desired vehicle behavior.

In the behavior planning, trajectory and maneuver planning for such a vehicle system or the control thereof, it may be considered when or how these certain requirements, in particular safety requirements, are fulfilled, in particular, whether actually correct or safe driving behavior is prompted in response to particular situation analyses or predictions.

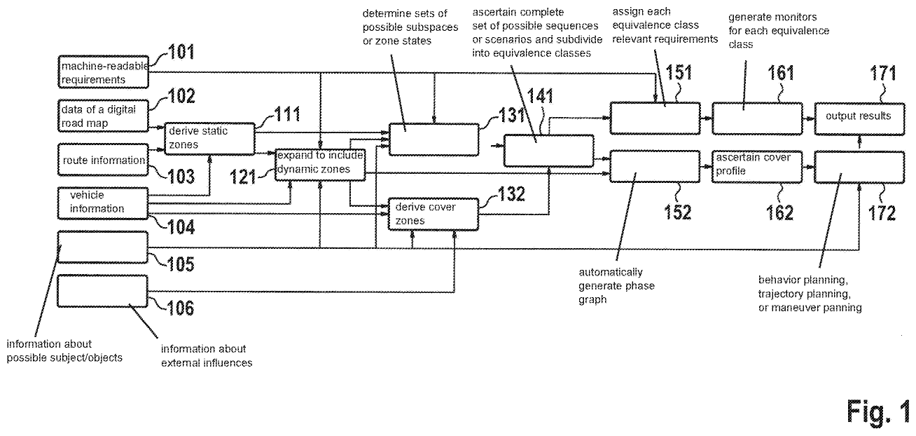

FIG. 1 shows the exemplary sequence of a method for testing a vehicle system.

The following possible input variables 101 through 106 are shown in the first column of the diagram:
machine-readable requirements 101 of the system from various sources, for example, derived from the road traffic regulations (for example, distances between vehicle, etc.), safety regulations or vehicle (system) specifications.
data of a digital road map 102, in particular, with a listing of the positions of pedestrian crosswalks, signs, traffic lights, lanes, intersections, traffic circles, etc., for example, in the OpenDrive format or ascertained from an instantaneous surroundings detection or conveyed by a navigation system of the vehicle.
route information 103, for example, potential routes on a considered road map element or a route selected or predicted for the vehicle,
vehicle information 104, for example, potential vehicle states or an instantaneous vehicle state, in particular, including in each case particular vehicle characteristics such as weight, length, height, etc.,
information about possible subjects and/or objects 105, in particular, road users such as vehicles (bicycle, car, motorcycle, etc.) or pedestrians, preferably including behavior models or objects, which may impede an intended behavior of the vehicle including the vehicle system; in this case, a population with the possible subjects and/or objects may take place as a function of a surroundings detection of the vehicle,
pieces of information about external influences 106 such as, for example, weather data.

Method steps 111, 121, 131, 132, 141, 151, 152, 161, 162, 171 and 172 are shown in the additional columns of the diagram in FIG. 1.

In step 111, static zones for the digital map are derived on the basis of particular input variables, in particular, as a function of digital map 102, of route information 103 and of vehicle information 104, for example, of the vehicle length. The static zones may be calculated automatically from such pieces of information. The logical zones thus calculated are, in particular, fixed and may be mapped onto the corresponding physical elements of the map (i.e., the roads or road lanes, the pedestrian crosswalks, etc.). The static zones may be joined together to form a static zone graph.

Static zones in this case are, in particular, zones that include a variable separate from the speed of the vehicle under consideration such as, for example, a given pedestrian crosswalk or an intersection area. They may be derived automatically from the map.

In step 121, an expansion to include dynamic zones takes place, in particular, the static zone graph may be expanded to include the dynamic zones to form a dynamic zone graph. Dynamic zones are automatically calculated preferably on the basis of models of the individual subjects, on the basis of requirements of the allowable maneuvering of the vehicle and on the pieces of vehicle information. This calculation advantageously expands automatically by the use of models to other road users to be considered and is applicable to arbitrary types of roads (urban, expressway, etc.). The models, such as behavior models in particular, are used, in particular, for calculating, coming from which area (zones), other road users must still be taken into account for a (possible) later decision of the vehicle under consideration.

Dynamic zones in this case are, in particular, zones including a speed-dependent variable such as, for example, the zone before a traffic light, in which the vehicle under consideration is just able or is just no longer able to stop at a comfortable deceleration before the stop line when the traffic light switches to “yellow.” The dynamic zones are, in particular, a function of position, speed and behavior models of the vehicle under consideration and/or of the positions, speeds and behavior models of other subjects or road users. The behavior models are, in particular, (physical) [behavior models] for the respective objects. The dynamic zones may optionally also be a function of external influences such as, for example, the weather, for example, due to an extended braking distance in the case of icy conditions.

There are zones, whose location is relative to the position of the vehicle under consideration such as, for example, the open space ahead of the vehicle under consideration and zones that have an absolute location such as, for example, a given intersection zone on a real map.

The zones in the zone graphs, and thus the zone graphs, represent abstractions of the respective situations in such a way that they are separate from specific structures of the digital map, such as curve radii or angles of an intersection. These logical zones may be mapped as physical zones onto the map.

Cover zones may be derived in a step 132. Cover zones thus refer, in particular, to defined zones that are partially or wholly covered by sensor systems such as cameras, radar, etc. of the vehicle under consideration. The ascertainment of which of the previously identified or derived zones are cover zones may be derived, in particular, as a function of pieces of information of the digital map, of pieces of information about external influences (visibility, snow on the road) and/or of the vehicle position. A comparison, in particular, may be made between zones that are (potentially) relevant for a scenario and the zones that are covered in a scenario, in order to derive a weakness of the vehicle system therefrom.

A cover in this case may result, for example, from external influences (for example, weather such as fog), roadside development, other road users, etc.

In a step 131, a set of possible subspaces or zone states may be determined per each identified or derived zone. The states free, occupied and threatened are preferably defined as possible zone states. Occupied means, in particular, that a subject other than the vehicle under consideration is located there, i.e., for example, a road user. Threatened means, in particular, that another subject, in particular, a road user, potentially occupies the zone on the basis of its assigned model, if the vehicle under consideration wishes to pass this zone. Free means, in particular, that the zone is not occupied and not threatened. The set of potential subspaces or zone states is determined preferably via a Zwicky box, which combines all relevant characteristics of the existing subjects and all manifestations allowable for the characteristics, among which the zone is either free or occupied or threatened.

With a behavior analysis, it is then possible to analyze systematically and fully the scope of the possible scenarios and to fully and consistently divide them into equivalence classes. An equivalence class in this case includes all situations, in which the vehicle under consideration behaves identically or should behave identically.

For this purpose, the complete set of possible sequences or scenarios for the existing combination made up of digital map, vehicle under consideration, subject behavior and additional input variables is ascertained in a step 141 from the determined, dynamic zone graphs and using the ascertained subspaces, and is subdivided into equivalence classes. In this case, each combination of influence factors, among which the vehicle under consideration is intended to show or shows a particular identical behavior in a determined zone, is placed in the same equivalence class.

Each equivalence class is assigned the relevant requirements in a step 151. The requirement therefor is present in a machine-readable form. They may be present, for example, as “permitted behavior,” “behavior not permitted” or “obligatory behavior.” Obligatory, damage-reducing behaviors may also be stored as requirements.

In a step 161, monitors are automatically generated for each equivalence class, which monitor or predict whether the vehicle under consideration is in the corresponding equivalence class and whether the vehicle system fulfills the requirements assigned to this equivalence class, i.e., in particular, behaves in accordance with the test specifications.

In this case, the monitors may be generated specifically to monitor the ODD (operative design domain), i.e., for the class of scenarios or requirements for which the vehicle system is to be designed or tested.

The monitors in this case may run at another, in particular, slower clocking than possible regulators in the vehicle under consideration.

In a step 152, a phase graph may be automatically generated on the basis of the zone graph and of the defined equivalence class.

The phase graph enables in step 162 the ascertainment of a cover profile for the ascertained possible sequences via a systematic detection of all possible behavior processes for the vehicle under consideration and the adjustment using the variants thereof taken into account.

A particular process in the phase graph corresponds in this case to a sequence of determined zones in a particular order with a respectively defined equivalence class per zone. In this way, it may be automatically ensured using a cover profile (for example, path cover) that a specific, in particular, complete cover of the possible sequences is fulfilled.

In a step 172, a behavior planning, trajectory planning or maneuver planning for the vehicle or a control of the vehicle may take place on the basis of the possible sequences considered and analyzed for the fulfillment of requirements.

The populations of the individual zones including specific subjects and the determination of their starting points and starting states (i.e., speeds, etc.) may take place on the basis of a surroundings detection of the vehicle.

Automatically continuous parameters (so-called continuous subspaces within the equivalence classes) which may be varied, are also derived from the pieces of information about the vehicle and about the other subjects, in particular, road users included in the equivalence classes. Examples of such continuous parameters are, for example, friction coefficients, speeds or curve radii.

The output in step 171 is preferably the result of a behavior planning, trajectory planning or maneuver planning or control commands for the vehicle or for actuators of the vehicle.

The example methods may include the derivation of critical visibility ranges of a perception of the vehicle system from the physical zones and the comparison with the actual perception of the vehicle system. For this purpose, it may be ascertained, in particular, whether or not the seeing of a particular zone for fulfilling requirements of the vehicle system is necessary. From this, it is possible in turn to derive requirements of a sensor architecture of the vehicle system or of the vehicle. Distance-dependent metrics may also be used in the process, i.e., the dependency of a perception on the distance of the vehicle under consideration to a particular zone to be seen is taken into account.

To assess a perception of the vehicle, it is possible in this case to take additional input variables into account. Such input variables may include perception metrics, in particular, standard metrics for the evaluation of a perception quality.

The vehicle may then be controlled also as a function of the completed analysis of the perception.

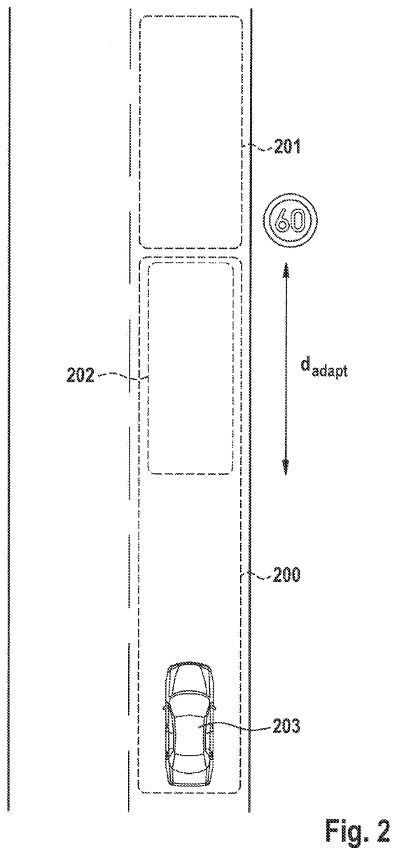

FIG. 2 schematically shows a simple road segment of a digital road map including two lanes and vehicle 203 under consideration. Also depicted is a traffic sign with a speed limit of 60. The traffic sign with a speed limit of 60 results in a static zone 201 in the relevant lane, from which point the new speed specification applies, as well as a static zone 200, in which the new speed specification does not yet apply. A dynamic zone 202 may also be derived as a function of the speed of vehicle 203 under consideration, in which vehicle 203 is able to sufficiently decelerate to the permitted speed before the traffic sign (d_{adapt}), in particular, at a safe and preferably comfortable deceleration.

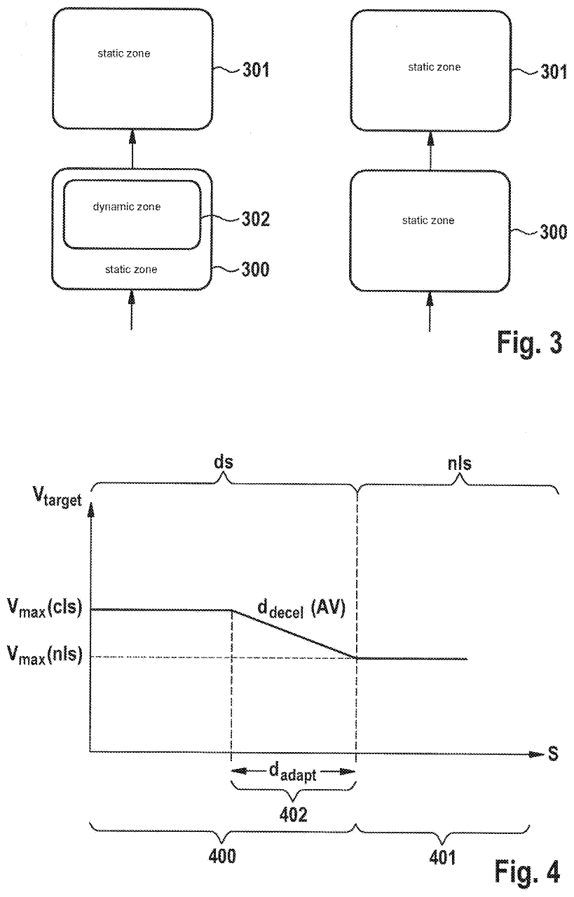

Two zone graphs derived with respect to the scenario shown in FIG. 2 are then shown in FIG. 3. In this case, the zone graphs correspond to a linking of logical zones derived from the physical zones of the map. Two possible zone graphs result as a function of the speed of the vehicle. In addition to static zones 301 and 300, dynamic zone 302 explained with respect to FIG. 2, which corresponds to a still sufficient deceleration distance, is also included in the first zone graph. This dynamic zone as a function of the vehicle speed is not included in the second zone graph, for example, because the vehicle is already travelling at a sufficiently slow speed.

Forming the behavior space are then sequences, which are a function, for example, of the following variables and their possible manifestations:
instantaneous maximum speed
   lower target speed after the traffic sign
   same target speed after the traffic sign
   higher target speed after the traffic sign
instantaneous speed
   lower instantaneous target speed
   same instantaneous target speed
   higher instantaneous target speed
Distance of vehicle to traffic sign
   less than adaptation distance
   same as adaptation distance
   greater than adaptation distance

The adaptation distance in this case refers to the previously described deceleration distance, in which a, in particular, safe and comfortable deceleration is still possible.

On the basis of such a listing, it is possible to systematically consider or predict all possible scenarios. The complexity of the scenarios is significantly reduced by the abstraction into logical zones, by the selection of relevant parameters and by the division into relative parameter ranges. By selecting the parameters and parameter ranges in mutually exclusive alternatives, it is possible to determine scenarios independent of one another, which completely cover the scope of possible scenarios.

FIG. 4 shows a diagram relating to a parametric behavior model of the vehicle under consideration associated with the first zone graph from FIG. 3. In this case, a target speed v_{target} is plotted over a distance s. The static zones from FIG. 3, here as 400, or ds, and 401, or nls, and the dynamic zone from FIG. 3, here 402, are also shown. The maximum speed of instantaneous zone vₘₐₓ(cls) and thus the instantaneous speed of the vehicle under consideration is above maximum speed vₘₐₓ(nls) allowable after the traffic sign; accordingly, a deceleration takes place within dynamic zone 402 or d_{adapt}, a deceleration c_{decel}(AV) from instantaneous speed vₘₐₓ(cls) to the then maximum allowable speed vₘₐₓ(nls).

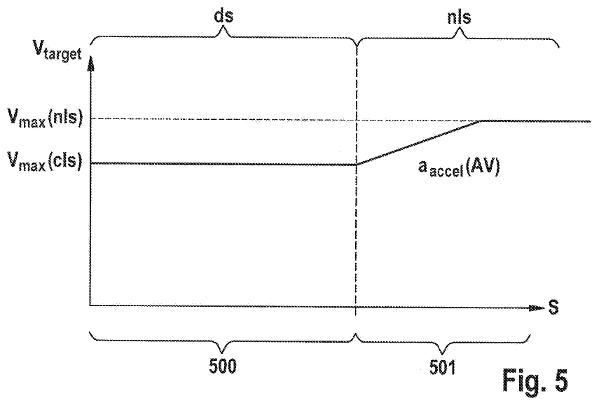

FIG. 5 shows a diagram relating to a parametric behavior model of the vehicle under consideration associated with the second zone graph from FIG. 3. In this case, a target speed v_{target} is plotted over a distance s. The static zones from FIG. 3 are also shown, here as 500, or ds, and 501, or nls. The maximum speed of instantaneous zone vₘₐₓ(cls) and, thus, the instantaneous speed of the vehicle under consideration is below the maximum speed allowable vₘₐₓ(nls) after the traffic sign; accordingly, an acceleration a_{accel}(AV) takes place within static zone 500, or ds, from an instantaneous speed vₘₐₓ(cls) to the then maximum allowable speed vₘₐₓ(nls).

Such behavior models preferably take traffic regulations, dynamic constraints, system constraints and comfort constraints into account. The specific form of the model is largely irrelevant. The behavior analysis, including the concepts used therein, such as particular distances, speeds, accelerations and comfort variables such as a quiet ride, is to be carried out preferably in such a way that it remains stable in wide areas even when the model parameters of the behavior models are changed. As a result, the behavior analysis is applicable largely independent of the specific parameters of the behavior model and thus to many different situations. Prerequisite therefor is the suitable selection of the abstractions in the behavior analysis.

The generic behavior for “following an empty lane including static constraints” depicted in FIGS. 2 through 5 is hierarchically subordinated to each behavior in a specific situation such as, for example, the “turning right in an intersection with traffic lights and pedestrian crosswalks.”

The corresponding behavior spaces are preferably hierarchically structured. The basic behavior for each road segment is provided, in particular, by the longitudinal behavior “following an empty lane with static constraints.” Empty in this case means empty of other subjects or road users. Static constraints may, for example, be speed limits, lane narrowing, curves, etc., which result in another maximum speed for the next road segment. Due to the distance to the future constraint and the instantaneous speed, the vehicle under consideration must adapt the speed accordingly, if necessary.

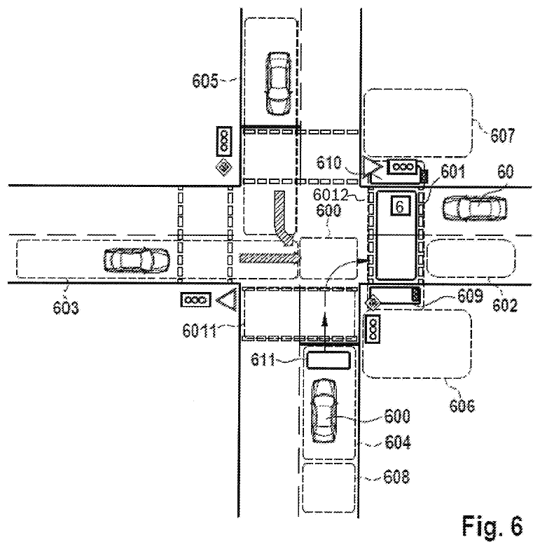

FIG. 6 depicts the schematic diagram of a four-way intersection including traffic signals, traffic signs, pedestrian crosswalks 6011 and 6012, vehicle under consideration 600, as well as additional road users (additional vehicles, for example, 60, and pedestrian 6), in which vehicle under consideration 600 intends to turn right.

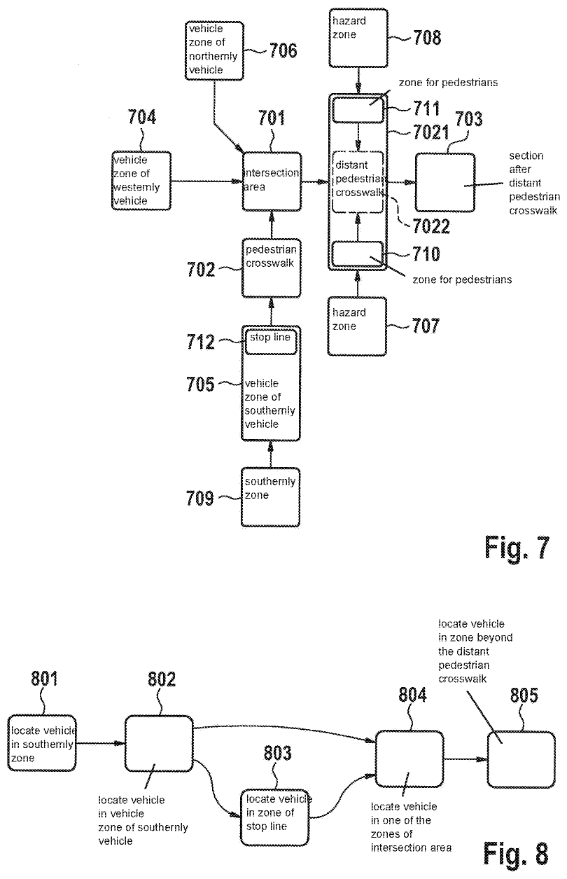

Relevant zones 600, 602, 603, 604, 605, 606, 607, 608, 609, 610, 611 for the behavior analysis outlined in the following images of FIGS. 7 and 8 are also plotted.

The following static zones result:
intersection area 600
near pedestrian crosswalk 6011
distant pedestrian crosswalk per se (on the road) 601
distant pedestrian crosswalk in the broader sense (for example, including waiting area) 6012
section after distant pedestrian crosswalk 602

The following dynamic zones also result:
vehicle zone of westerly vehicle 603
vehicle zone of southerly vehicle 604
vehicle zone of northerly vehicle 605
zones for pedestrians on both sides of distant pedestrian crosswalk 609, 610
southerly zone, far away from the intersection (zone after the vehicle under consideration in FIG. 6) 608
stop line before near pedestrian crosswalk 611
hazard zones of pedestrians, who could enter the distant pedestrian crosswalk, on both sides of distant pedestrian crosswalk 606, 607

In the associated behavior analysis, only the specifics of “turning right in a four-way intersection including pedestrian crosswalks,” for example, are considered. Thus, it is then presupposed that the behavior of “turning right at a green light, with no pedestrians and with no additional other road users,” which corresponds to the “following an empty lane including static constraints,” is already controlled and is therefore no longer explicitly described. The static constraints are provided here essentially by the generally permitted maximum speed, the lane widths, lane gradients (longitudinal or transverse) and the curve radius of the required turning trajectory.

FIG. 7 depicts a corresponding zone graph for the zones shown in FIG. 6.

Static zones:
intersection area 701
near pedestrian crosswalk 702
distant pedestrian crosswalk per se (on the road) 7022
distant pedestrian crosswalk in the broader sense (for example, including waiting area) 7021
section after distant pedestrian crosswalk 703

Dynamic zones:
vehicle zone of westerly vehicle 704
vehicle zone of southerly vehicle 705
vehicle zone of northerly vehicle 706
zone for pedestrians on both sides of distant pedestrian crosswalk 710, 711
southerly zone, far away from intersection 709
stop line before near pedestrian crosswalk 712
hazard zones of pedestrians, who could enter the distant pedestrian crosswalk, on both sides of distant pedestrian crosswalk 707, 708

A phase graph is depicted in FIG. 8 for the scenario from FIGS. 6 and 7. In this scenario, the vehicle under consideration is located initially in phase 801 in the zone (in FIG. 6 in the southerly zone, far away from the intersection), in phase 802 in the vehicle zone of the southerly vehicle (in FIG. 6, the zone of the vehicle under consideration), in phase 803 in the zone of the stop line before the near pedestrian crosswalk, in phase 804 in one of the zones of the intersection area, near pedestrian crosswalk or distant pedestrian crosswalk, and in phase 805 in the zone beyond the distant pedestrian crosswalk. The possible transitions are marked with arrows. Thus, the vehicle may or may not come to a stop depending on the situation in the stopping area before the near pedestrian crosswalk, i.e., a phase transition from phase 802 to phase 804 directly or via phase 803.

In this case, parameter combinations for parameters, such as speed, acceleration, position in the lane of the vehicle under consideration are defined as equivalence classes, which result in an identical setpoint behavior of the vehicle under consideration. Monitors are generatable for each equivalence class which check the behavior of the vehicle under consideration or vehicle system observed in a simulation and thus predicted as to whether the specifications of the equivalence classes are complied with.

A projection of the equivalence classes on the zones for an observed analyzed road segment including a potential subject population and a predefined intention (mission) of the vehicle under consideration provides the phases of the movement of the vehicle under consideration through the zones of the road segment, while taking the behavior of the observed subject population into account.

A phase is formed by the subset of the equivalence classes of the behavior analysis of the road segment, which may occur in the relevant zone. Depending on the size of the zone, the vehicle under consideration may switch back and forth within the zone and between the equivalence classes of the phase as well, for example, in a large zone in stop-and-go traffic, with multiple switches between starting, rolling, stopping, waiting.

The succession of the phases when driving through the road segment forms a phase graph. The vehicle under consideration is always located in one phase and in each phase in exactly one of the equivalence classes that form this phase.

More complex phase graphs may form dynamically if, for example, the intended route of the vehicle under consideration is permanently blocked, for example, by an accident. A new route may then be calculated, which typically results in a locally different intention of the vehicle under consideration and, therefore, to new phases, zones, etc. This may be controlled by the vehicle under consideration if the necessary maneuvers (for example, turning around or backing up in the lane and turning at the earliest point possible) are controlled and the road segments to be expected on the substitute route are also controlled by the vehicle under consideration.

The phases provide the basis of the compositionality for the behavior of the vehicle under consideration. Provided that each analysis of a road segment possesses an entry zone and an exit zone, and thus an input phase and an output phase, compositionality is possible on the topological level of the road segments and on the behavior level of the phases. In this case, the entry zone of the following segment, in particular, includes the exit zone of the preceding segment.

The exit zone of a road segment may preferably fully accommodate the vehicle under consideration, but should not be much larger so that the departure from the respective segment is possible under minimal conditions. The entry zone of a road segment is normally a zone far removed from the vehicle under consideration with respect to the relevant portion of the road segment (intersection, traffic circle, etc.).

Analyses are preferably carried out for particular, generic road segments (simple road segments, simple intersections, simple traffic circle, simple parking lot, etc.) and stored as models in a corresponding model library. Relatively few such generic models are sufficient for covering a large portion of all possible or actually existing road segments. With a selection of the relevant characteristics of such generic road segments, it is thus possible to create a small configurable and parameterizable model library, on the basis of which more complex road maps may then be easily calculated. Thus, for example, T-intersections of different types may be produced from the generic model of a four-way intersection by omitting one branch of the intersection. The angles between the branches of the intersection, the lane widths, the number of lanes, the placement of yield signs and traffic signals may, in particular, be parameters in the models.

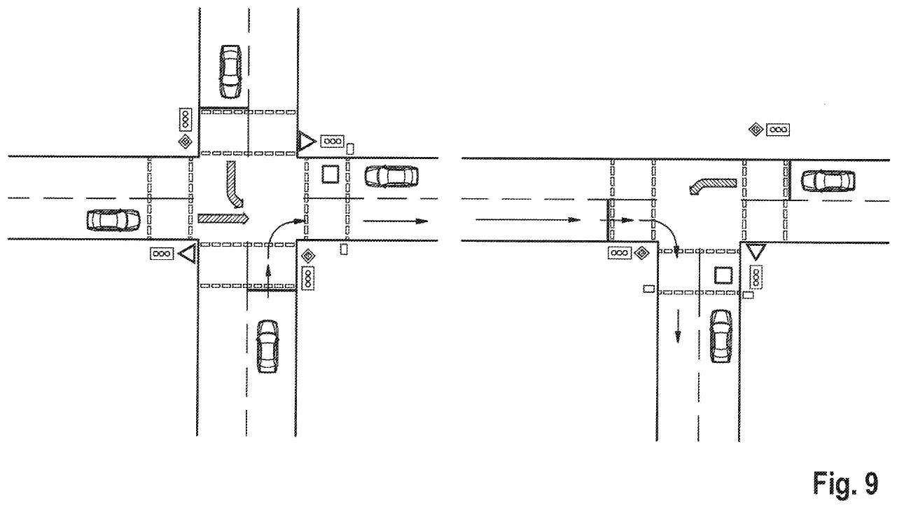

Two road map segments are shown in FIG. 9 in the form of road schemes, which may be combined. The road map segments include:
the vehicle under consideration starting on the left side below, whose intended maneuver is marked by a sequence of thin arrows and guides the vehicle on the right side below,
additional road users (vehicles with intended maneuvers marked by thick arrows, pedestrians as boxes),
traffic lights and traffic signs,
pedestrian crosswalks.

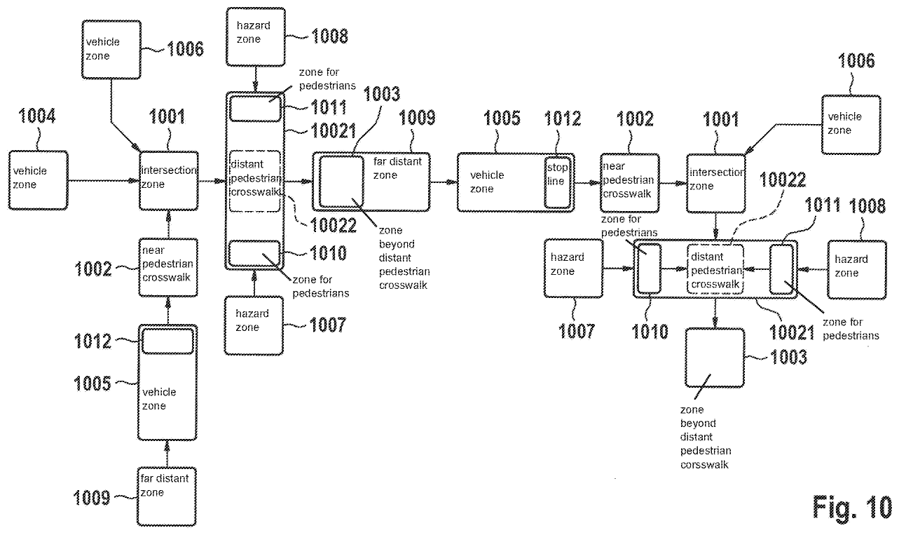

FIG. 10 shows a zone graph relating to the road map segments in FIG. 9. In this case, the zones on the left side and the zones on the right side in FIG. 10 relating to the left and right road map segment in FIG. 9 have been ascertained. Identical zones are identified by the same reference numeral:
intersection zone 1001,
far distant zone 1009,
near pedestrian crosswalk 1002,
distant pedestrian crosswalk with associated zones for pedestrians and hazard zones for pedestrians 10021, 10022, 1010, 1011, 1007, 1008,
vehicle zones 1004, 1005, 1006,
stop lines 1012,
zone beyond the distant pedestrian crosswalk 1003.

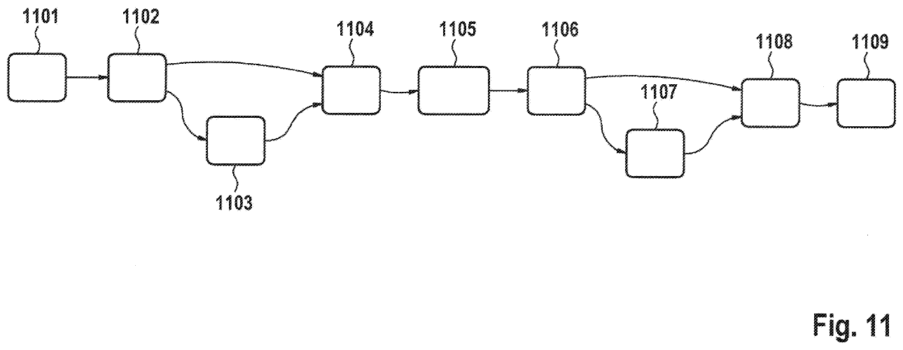

FIG. 11 shows a phase graph relating to the zone graph in FIG. 10. In this case, the phases 1101 through 1104 on the left side and the phases 1106 through 1109 on the right side in FIG. 11 relating to the left and right part of the zone graph in FIG. 10 have been ascertained. Phase 1105 between the two sections represents the transition and corresponds to a transition between the zone graphs in FIG. 10 as well as between the map segments in FIG. 11.

If two or multiple road map segments have already been considered, for example, stored in a model library, then it is sufficient for a more complex road map scenario, which is constructed from the road map segments including transitions, if only the unknown transitions are considered once again. Apart from that, it is possible to resort to the previously completed analyses.

By automatically abstracting a given map into a logical zone graph for the possible maneuver on the map, it is possible to ascertain exact pieces of information about which components of the map in the analyses carried out with the method are already controlled and which must still be considered.

With the selected abstractions (zones, equivalence classes, phases), a structural compositionality and a behavior compositionality are achieved. The structural compositionality makes the connection of multiple base elements (for example, straight road and curve) possible on the basis of the zones. With the behavior compositionality, made possible by the definition of phases, the certainty that a consideration of individual elements in the analysis is sufficient for correct behavior on complex maps is obtained.

What is claimed is:

1. A computer-implemented method for controlling a vehicle, comprising the following steps:
reading in data of a digital road map;
determining zones for the digital road map;
ascertaining possible sequences of drives along a road of the digital road map as a function of the determined zones;
ascertaining a behavior of the vehicle or of a vehicle system of the vehicle in a simulation for at least one of the possible sequences; and
controlling the vehicle in accordance with one of the possible sequences as a function of a comparison of the ascertained behavior with at least one predetermined requirement.

2. The method as recited in claim 1, wherein the method is carried out in a vehicle during a driving operation.

3. The method as recited in claim 1, wherein the controlling of the vehicle includes control commands to a vehicle component for steering the vehicle, or decelerating the vehicle, or accelerating the vehicle.

4. The method as recited in claim 1, the method further comprising the following step:
performing a behavior planning or trajectory planning as a function of the comparison;
wherein the controlling takes place as a function of a result of the behavior planning or the trajectory planning.

5. The method as recited in claim 2, wherein one of the possible sequences is selected as a function of whether or to what extent the vehicle or a vehicle system of the vehicle fulfills the requirement for the one of the possible sequences.

6. The method as recited in claim 1, wherein the determined zones include: (i) at least one static zone, a size of which results from static elements of the digital road map, and (ii) at least one dynamic zone, the size of which is a function of a characteristic of at least one additional road user, or of a dynamic state of the additional road user, or of a characteristic of the vehicle, or of a dynamic state of the vehicle.

7. The method as recited in claim 6, wherein the characteristic of the at least one additional road user is ascertained from a physical movement model relating to the road user.

8. The method as recited in claim 1, wherein the determined zones for the digital map are determined as logical zones, and a zone graph relating to the determined zones of the digital map is ascertained, as a function of which the possible sequences are ascertained.

9. The method as recited in claim 8, wherein the possible sequences are subdivided into equivalence classes, those sequences of the possible sequences being subdivided into the same equivalence class in which an identical setpoint behavior for the vehicle applies.

10. The method as recited in claim 9, wherein a phase graph is generated as a function of the zone graph and of the equivalence classes, as a function of which the possible sequences are ascertained.

11. The method as recited in claim 9, wherein a cover profile for the possible sequences is determined as a function of the subdivision into equivalence classes.

12. The method as recited in claim 1, wherein zones for which a cover is critical are identified based on the digital map, on the determined zones, and on the possible sequences.

13. The method as recited in claim 12, wherein the controlling takes place as a function of a determined possible cover for the identified zones based on input variables.

14. The method as recited in claim 13, wherein the input variables include pieces of information about external influences including weather data, or pieces of road information, or pieces of development information, or pieces of information about additional road users including their size, or pieces of information about sensors of the vehicle.

15. The method as recited in claim 12, wherein requirements for a perception of the vehicle are created as a function of the identified zones and the controlling takes place as a function of the requirements for the perception.

16. The method as recited in claim 1, further comprising the following step:
when none of the possible sequences fulfills the requirement, outputting an error message or deactivating the vehicle system or transferring the vehicle into a safe state or carrying out a substitute reaction.

17. The method as recited in claim 1, wherein the vehicle is automatically improved if none of the possible sequences fulfills the requirement.

18. The method as recited in claim 1, wherein the digital map contains pieces of information about at least one road, including about roadway markings, intersections, traffic lights, and traffic signs.

19. The method as recited in claim 1, wherein the digital map contains pieces of information about roadway width, roadway boundaries, positions or extensions of road or open space, curve radii, roadway markings, intersections, traffic lights and traffic signs.

20. The method as recited in claim 1, wherein the ascertaining of the possible sequences is a function of pieces of information about at least one additional road user, or of pieces of information about an object, which impedes an intended behavior of the vehicle.

21. The method as recited in claim 1, wherein the possible sequences are ascertained as a function of additional input variables, including pieces of information about external influences, or pieces of information about additional road users, or pieces of information about an existing or planned route of the vehicle, or pieces of information about the vehicle.

22. The method as recited in claim 1, wherein the predetermined requirement includes a traffic regulation, or a safety requirement for a movement behavior of the vehicle, or a comfort requirement according to a specification of the vehicle.

23. The method as recited in claim 1, wherein results of a previous ascertainment for segments of the digital map are used for ascertaining the possible sequences for a digital map.

24. The method as recited in claim 23, wherein a new ascertainment of the possible sequences takes place for a transition between the segments.

25. A non-transitory machine-readable memory on which is stored a computer program for controlling a vehicle, the computer program, when executed by a computer, causing the computer to perform the following steps:
reading in data of a digital road map;
determining zones for the digital road map;
ascertaining possible sequences of drives along a road of the digital road map as a function of the determined zones;
ascertaining a behavior of the vehicle or of a vehicle system of the vehicle in a simulation for at least one of the possible sequences; and
controlling the vehicle in accordance with one of the possible sequences as a function of a comparison of the ascertained behavior with at least one predetermined requirement.

26. A vehicle configured to:
read in data of a digital road map;
determine zones for the digital road map;
ascertain possible sequences of drives along a road of the digital road map as a function of the determined zones;
ascertain a behavior of the vehicle or of a vehicle system of the vehicle in a simulation for at least one of the possible sequences; and
control the vehicle in accordance with one of the possible sequences as a function of a comparison of the ascertained behavior with at least one predetermined requirement.
